(19) United States
(12) Patent Application Publication
(10) Pub. No.: US 2006/0112338 A1
(43) Pub. Date: May 25, 2006

(54) Device and method for editing, authoring, and retrieving object-based mpeg-4 contents

(76) Inventors: Ye-Sun Joung, Daejon (KR); Kyu-Heon Kim, Daejeon (KR); Kyeong-Ok Kang, Daejeon (KR); Jin-Woong Kim, Daejeon (KR)

Correspondence Address: Blakely Sokoloff Taylor & Zafman, 12400 Wilshire Boulevard, 7th Floor, Los Angeles, CA, 90025, US

(21) Appl. No.: 10/532,571

(22) PCT Filed: Oct. 22, 2003
(86) PCT No.: PCT/KR03/02232

§ 371 Date: Jan. 23, 2006

(30) Foreign Application Priority Data
Oct. 22, 2002 (KR) 10-2002-0064413

(51) Int. Cl. H04N 7/12; G06F 3/00

(52) U.S. Cl. 715/733; 375/240.08

(57) ABSTRACT

In a device for editing and authoring object-based AV (audio and visual) contents using the MPEG-4 method, an object-based MPEG-4 (moving picture experts group 4) contents editing and authoring device comprises: an extensible description generator for receiving either of an MPEG-4 textual format or internal data structure information of object-based MPEG-4 contents, and MPEG-7 (moving picture experts group 7) descriptions of the MPEG-4 contents, and generating an XML (extensible markup language) based textual format file including the MPEG-7 descriptions; an extensible description/binary converter for receiving the XML based textual format file including the MPEG-7 descriptions generated by the extensible description generator, and generating them as a binary file; and an XML based contents storage unit for storing the XML based textual format file generated by the extensible description generator and the binary file generated by the extensible description/binary converter.

### CROSS REFERENCE TO RELATED APPLICATION

This application claims priority to and the benefit of Korea Patent Application No. 2002-64413 filed on Oct. 22, 2002 in the Korean Intellectual Property Office, the content of which is incorporated herein by reference.

### BACKGROUND OF THE INVENTION

(a) Field of the Invention

The present invention relates to authoring and retrieval of object-based AV (audio-visual) contents. More specifically, the present invention relates to a device and method for editing, authoring, and retrieving object-based MPEG-4 (moving picture experts group 4) contents for unifying MPEG-7 (moving picture experts group 7) descriptions with MPEG-4 scene descriptions to author new object-based AV contents and retrieve them.

(b) Description of the Related Art

Recent developments of computer environments have increased usage of AV contents, and techniques for indexing contents that include scenes and sound desired by users from among the increased AV contents have also been developed.

Conventional AV contents indexing methods include a text indexing method and a content-based indexing method.

The text indexing method sorts the AV contents into text indexes with respect to keywords, and in addition a user represents the AV contents through keywords based on their personal views. However, the text indexing method generates high error rates because of limitations of text, and causes problems in checking a huge volume of AV contents, defining them with keywords, making lists on them, and retrieving them.

The content-based indexing method automatically extracts features from the AV contents according to an indexing request to index them, and since this method requires much time to extract the features of the AV contents, it wastes feature extracting time each time the indexing is requested.

To solve the problems, MPEG-7 standardization has been furthered for improving the AV contents indexing method and providing a more efficient indexing method.

MPEG-7 includes descriptors for representing the features of the AV contents, descript configurations for combining the descriptors, and descriptions for representing the descript configurations, and accordingly provides effective indexing methods by making up for demerits of the text indexing and content-based indexing methods.

Also, as to a multimedia data producing and retrieving system, Korean published application No. 2001-0064252 (Application filing No. 10-1999-0062402, titling “XML based multimedia data producing and retrieving system, and a multimedia data producing method using the system”) discloses a system for combining index information and multimedia data on the XML (extensible markup language) basis to produce and retrieve new multimedia data, and a multimedia data-producing method using the system.

The above-noted publication for displaying the multimedia data on the XML basis receives multimedia data, divides them into respective scenes, converts retrieval information on each scene into MPEG-7 descriptions following the input XML documents, and inserts the MPEG-7 descriptions generated per scene into data to produce new multimedia data, thereby allowing convenient multimedia data management and structural retrieval.

However, since the above-mentioned method cannot describe the AV contents in detail when attempting to retrieve the AV data used for the object-based AV contents represented through descriptions of the MPEG-4 scenes, it is impossible to obtain efficient retrieval results and perform a function of retrieving the object-based AV contents generated by the current MPEG-4 scene description standard.

### SUMMARY OF THE INVENTION

It is an advantage of the present invention to provide an object-based MPEG-4 contents edit/author and retrieve device and method for using MPEG-7 description techniques in the retrieval of object-based AV (audio and visual) contents in the MPEG-4 (moving picture experts group 4) format to allow editing and authoring of new object-based AV contents, and to provide convenience of contents retrieval by a user request.

In one aspect of the present invention, in a device for editing and authoring object-based AV contents using the MPEG-4 method, an object-based MPEG-4 contents editing and authoring device comprises:

an extensible description generator for receiving either of an MPEG-4 textual format or internal data structure information of object-based MPEG-4 contents, and MPEG-7 (moving picture experts group 7) descriptions of the MPEG-4 contents, and generating an XML (extensible markup language) based textual format file including the MPEG-7 descriptions;

an extensible description/binary converter for receiving the XML based textual format file including the MPEG-7 descriptions generated by the extensible description generator, and generating them as a binary file; and

an XML based contents storage unit for storing the XML based textual format file generated by the extensible description generator and the binary file generated by the extensible description/binary converter.

The device further comprises: an MPEG-4 contents storage unit for storing the object-based MPEG-4 contents; and an MPEG-7 description generator for generating MPEG-7 descriptions of the MPEG-4 contents stored in the MPEG-4 contents storage unit.

The XML based contents storage unit stores either of the textual format or the binary file generated on the XML basis, and storage information of the MPEG-4 contents storage unit of the MPEG-4 contents related to the corresponding XML based file.

In another aspect of the present invention, an object-based MPEG-4 contents editing and authoring method comprises: receiving one of a textual file and an internal data structure of object-based MPEG-4 contents stored in a contents database; receiving MPEG-7 descriptions of the object-based MPEG-4 contents; and combining either of the textual file or the internal data structure of the object-based MPEG-4 contents with the MPEG-7 descriptions, generating them into an XML based textual format file, and storing the XML based textual format file.

The method further comprises converting the XML based textual format file into a binary file, and storing the binary file.

In still another aspect of the present invention, an object-based MPEG-4 contents editing/authoring and retrieving device comprises: a contents editor/author for receiving either of an MPEG-4 textual format or internal data structure information of object-based MPEG-4 contents, and MPEG-7 descriptions of the MPEG-4 contents, combining them, editing or authoring them as an XML based textual format file or a binary file, and storing it; a contents storage unit for extracting MPEG-7 description information of the XML based textual format file edited, authored, and stored by the contents editor/author, and storing the MPEG-7 description information for a retrieval process; and a retrieval browser/reproducer for providing a user interface for retrieving MPEG-7 description information stored in the contents retriever, and reproducing the retrieved contents.

The contents editor/author comprises: an extensible description generator for receiving either of an MPEG-4 textual format or internal data structure information of object-based MPEG-4 contents, and MPEG-7 descriptions of the MPEG-4 contents, and generating an XML based textual format file including the MPEG-7 descriptions; an extensible description/binary converter for receiving the XML based textual format file including the MPEG-7 descriptions generated by the extensible description generator, and generating them as a binary file; and an XML based contents storage unit for storing the XML based textual format file generated by the extensible description generator and the binary file generated by the extensible description/binary converter.

The contents retriever comprises: a file parsing module for receiving the XML based textual format file or the binary file produced using the MPEG descriptions, and extracting MPEG-7 descriptions included in the corresponding file; an MPEG-7 description storage unit for generating the MPEG-7 description information extracted from the file parsing module into a database, and storing the information; and a retrieval module for retrieving the MPEG-7 description information stored in the MPEG-7 description storage unit according to a request by a user, and outputting corresponding results.

The retrieval browser/reproducer comprises: a retrieval browser for receiving a retrieval request from a user, commanding the contents retriever to perform retrieval, receiving retrieval results, and outputting them to the user; and a reproducer for reproducing the contents retrieved through the retrieval browser.

In still yet another aspect of the present invention, an object-based MPEG-4 contents retrieving method comprises: (a) receiving a user's request for contents retrieval through a retrieval browser, and retrieving MPEG-7 description information stored in an MPEG-7 description storage unit at a retrieval module; (b) receiving retrieval results from the retrieval browser, and displaying the retrieval results; (c) allowing the user to select desired contents from among the displayed results; and (d) loading the contents selected from the retrieval browser from a storage unit, and driving a reproducer to reproduce the loaded data.

The step (a) further comprises: allowing the user to input a keyword through the retrieval browser, and request retrieval; retrieving an MPEG-7 description information storage unit at the retrieval module by using the keyword; and generating retrieval results into a list and transmitting the list to the retrieval browser.

The step (d) comprises analyzing original contents storage information stored in the MPEG-7 description storage unit, and loading the original contents storage information.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of an object-based MPEG-4 contents editor/author and retriever according to a preferred embodiment of the present invention;

FIG. 2 shows a block diagram of the contents editor/author of FIG. 1 according to a preferred embodiment of the present invention;

FIG. 3 shows a method for combining a textual format file of MPEG-4 contents with MPEG-7 descriptions, and generating an XML based textual format file;

FIG. 4 shows a block diagram of the contents retriever of FIG. 1 according to a preferred embodiment of the present invention;

FIG. 5 shows a block diagram of a contents browser/reproducer of FIG. 1 according to a preferred embodiment of the present invention; and

FIG. 6 shows an operational flowchart of the object-based MPEG-4 contents retrieving method.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

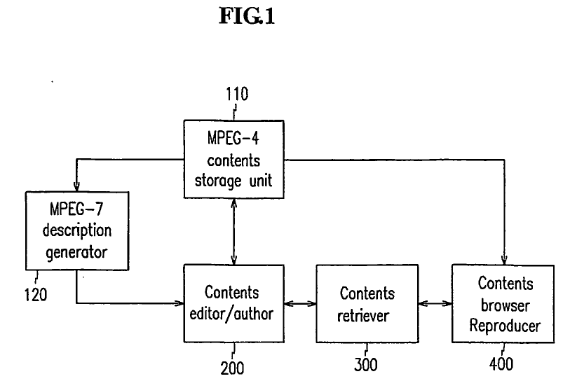

FIG. 1 shows a block diagram of an object-based MPEG-4 contents editor/author and retriever according to a preferred embodiment of the present invention.

As shown, the object-based MPEG-4 contents editor/author and retriever comprises an MPEG-4 contents storage unit 110, an MPEG-7 description generator 120, a contents editor/author 200, a contents retriever 300, and a contents browser/reproducer 400.

The MPEG-4 contents storage unit 110 stores AV contents produced on the object-basis according to the MPEG-4 standards.

The MPEG-7 description generator 120 produces the object-based MPEG-4 contents stored in the MPEG-4 contents storage unit 110 as descriptions that follows the MPEG-7 standard.

The contents editor/author 200 combines one of the textual file of the MPEG-4 contents stored in the MPEG-4 contents storage unit 110 and an internal data structure with the MPEG-7 descriptions produced by the MPEG-7 description generator 120 to edit or author them into an XML based textual format file (i.e., XMT; extensible MPEG-4 Textual format) or a binary file (i.e., BiFS; Binary Format for Scene description), and store the same.

In particular, the MPEG-7 description generator 120 generates MPEG-7 descriptions of the MPEG-4 contents stored in the MPEG-4 contents storage unit 110, and provides the MPEG-7 descriptions to the contents editor/author 200.

The contents retriever 300 divides and stores the MPEG-7 descriptions, retrieves MPEG-7 description information stored according to a retrieval request by a user, generates retrieval results as a list, and provides the list in order to retrieve the XML based textual format file or the binary file stored in the contents editor/author 200 or externally input by the user.

The contents browser/reproducer 400 allows the user to input desired retrieval conditions, displays retrieval results provided by the contents retriever 300, and reproduces AV contents according to a selection by the user.

Respective blocks in the object-based MPEG-4 contents editor/author and retriever are configured as follows.

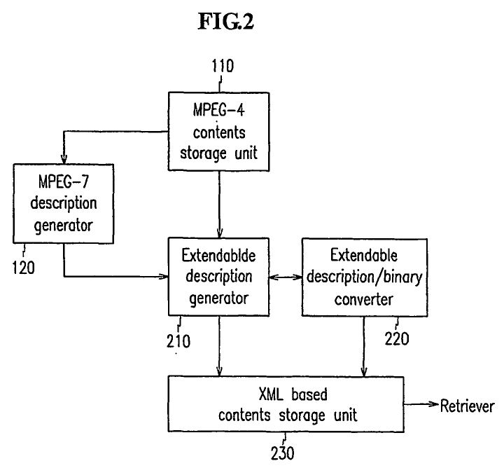

FIG. 2 shows a block diagram of the contents editor/author 200 of FIG. 1 according to a preferred embodiment of the present invention.

As shown, the contents editor/author 200 comprises an extensible description generator 210, an extensible description/binary converter 220, and an XML based contents storage unit 230.

The extensible description generator 210 combines one of the textual format and the data structure of the MPEG-4 contents stored in the MPEG-4 contents storage unit 110 with the MPEG-7 descriptions of the MPEG-4 contents generated by the MPEG-7 description generator 120 to generate an XML based textual format file.

In this instance, the extensible description generator 210 uses the MPEG-7 description information to insert additional information to the MPEG-4 scene description, and generates this as the XML based textual format.

An embodiment of combining the data structure or the textual format of the MPEG-4 contents with the MPEG-7 descriptions will now be described.

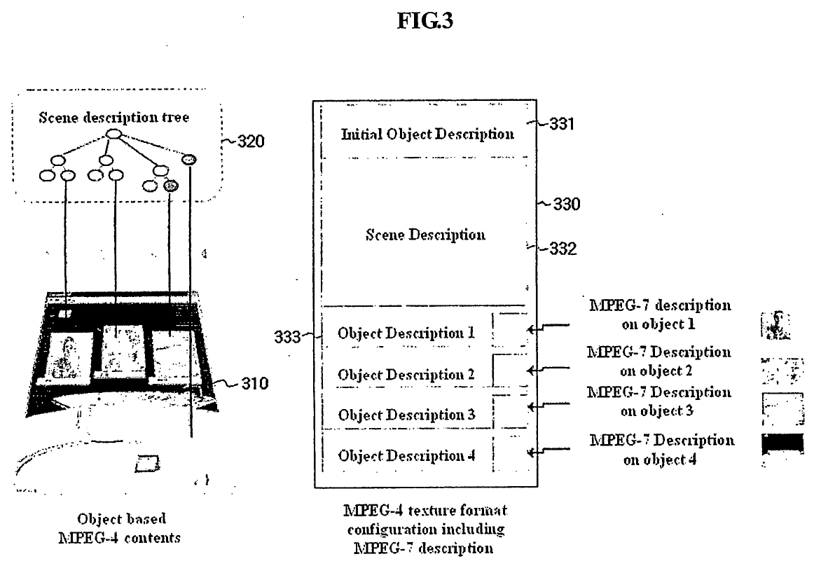

FIG. 3 shows a method for combining a textual format file of MPEG-4 contents with the MPEG-7 descriptions, and generating an XML based textual format file.

As shown, MPEG-4 contents 310 display a contents scene as a scene description tree 320.

The scene description tree 320 authors scenes per object unit such as video, audio, and still images, and the MPEG-4 contents can be shown as an XML based textual format file 330.

In this instance, the XML based textual format file 330 includes an initial object descriptor 310 for storing initial information on scene descriptions and descriptors used for scenes, scene descriptions 332, and object descriptors 333.

The MPEG-7 description information is added to the object descriptor 333, and the added result is added next to the initial object descriptor 331 and the scene descriptions 320 to thereby generate the XML based textual format file 330.

Further, the above-described method is an embodiment for combining the data structure or the textual format file of the MPEG-4 contents with the MPEG-7 descriptions to generate them into an XML based textual format file, and the data structure or the textual format file of the MPEG-4 contents can be combined with the MPEG-7 descriptions in various ways.

The extensible description/binary converter 220 converts the XML based textual format file generated by the extensible description generator 210 into a binary file. The XML based contents storage unit 230 stores the XML based textual format file generated by the extensible description generator 210 and the binary file generated by the extensible description/binary converter 220. The XML based contents storage unit 230 stores the MPEG-4 contents edited and authored on the XML basis using the MPEG-7 descriptions and the contents generated on the XML basis input by the user through another medium.

As described, the contents editor/author 200 adds MPEG-7 description information to the contents following the MPEG-4 standard, edits and authors them as XML based multimedia contents, and stores result data.

The contents editor/author 200 comprises an MPEG-4 contents storage unit 110 for storing MPEG-4 contents, and an MPEG-7 description generator 120 for generating MPEG-7 descriptions of the MPEG-4 contents stored in the MPEG-4 contents storage unit 110.

The contents editor/author 200 additionally comprises an input device to allow the user to input MPEG-4 contents to the input device, and convert the MPEG-4 contents into XML based contents using the MPEG-7 descriptions to use them, thereby providing a conversion function.

The contents retriever 300 extracts MPEG-7 description information of corresponding data and generates them into a database each time contents data of the XML based contents storage unit 230 of the contents editor/author 200 are added.

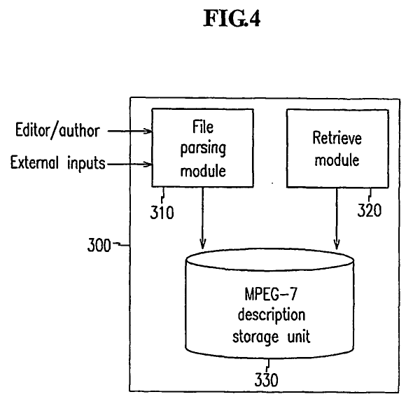

FIG. 4 shows a block diagram of the contents retriever 300 of FIG. 1 according to a preferred embodiment of the present invention.

As shown, the contents retriever 300 comprises a file parsing module 310, a retrieval module 320, and an MPEG-7 description storage unit 330.

The file parsing module 310 loads the XML based textual format or the binary file stored in the XML based contents storage unit 230 of the contents editor/author 200 and extracts MPEG-7 description information.

The retrieval module 320 stores contents according to requirements by the user, generates stored results as a list, and outputs the list.

The contents browser/reproducer 400 cooperates with the retrieval module 320 to receive a user's request, display results desired by the user, and reproduce AV contents.

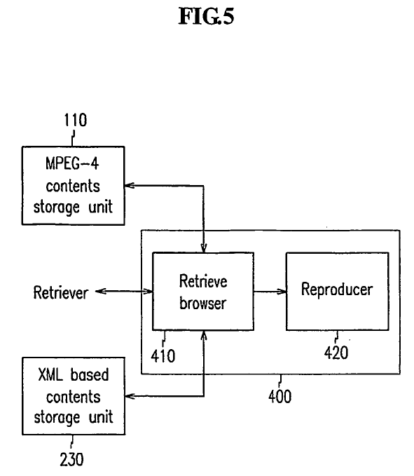

FIG. 5 shows a block diagram of a contents browser/reproducer 400 of FIG. 1 according to a preferred embodiment of the present invention.

Referring to FIG. 5, the contents browser/reproducer 400 comprises a retrieval browser 410 and a reproducer 420.

The retrieval browser 410 provides a user interface for allowing the user to input retrieval conditions, request a retrieval, and display retrieval results to the user.

The reproducer 420 reproduces AV contents selected by the user from among the AV contents retrieval results to the user through the retrieval browser 410.

A method for allowing the user to retrieve a huge volume of AV contents by using the object-based MPEG-4 contents edit/author and retrieve device will be described.

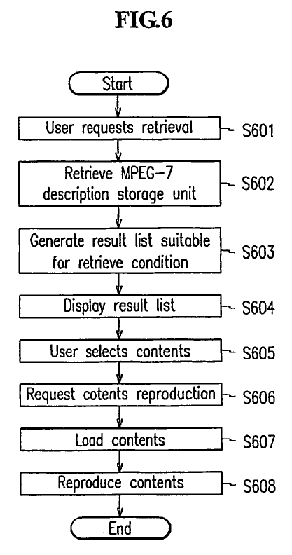

FIG. 6 shows an operational flowchart of the object-based MPEG-4 contents retrieving method.

Referring to FIG. 6, a user inputs a retrieval condition to the retrieval browser 410 through the contents browser/reproducer 400 to request contents retrieval in step S601.

The retrieval browser 410 transmits the user's retrieval conditions and request to the retrieval module 320 of the contents retriever 300, and the retrieval module 320 uses the retrieval conditions to retrieve the MPEG-7 description storage unit 330 in step S602.

The retrieval module 320 generates retrieved results into a list in step S603, and transmits the list to the retrieval browser 410. The retrieval browser 410 displays the received retrieval result list to the user in step S604, and the user selects a desired content from the list in step S605 to obtain further detailed information. When desiring to reproduce the selected AV contents, the user requests to reproduce the same using the interface provided by the retrieval browser 410 in step S606, and the retrieval browser 410 loads the corresponding contents in step S607 and drives the reproducer 420 to reproduce the contents in step S608.

As described, according to the preferred embodiment of the present invention, MPEG-7 descriptions are used to retrieve contents desired by the user from among a large amount of AV contents, the MPEG-7 descriptions are combined with MPEG-4 scene descriptions to be edited and authored into an XML based textual format file or a binary file, and be retrieved.

In order to solve the problem of retrieving the contents in the object-based AV contents system represented with the MPEG-4 data and propose a new object-based AV contents describing method, the object-based MPEG-4 contents edit/author and retrieve device according to the preferred embodiment of the present invention uses MPEG-7 descriptions to insert additional information into the MPEG-4 scene description in the AV contents producing process, generates them as an XML based texture or a binary file to provide a new object-based AV contents scene descriptions, and accordingly accumulate fundamental descriptions of MPEG-4 related system fields.

In addition, since the MPEG-7 descriptions are added, the AV contents are effectively and accurately retrieved according to retrieval requests by the user.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. In a device for editing and authoring object-based AV (audio and visual) contents using the MPEG-4(moving picture experts group 4) method, an object-based MPEG-4 contents editing and authoring device comprising:
an extensible description generator for receiving either of an MPEG-4 textual format or internal data structure information of object-based MPEG-4 contents, and MPEG-7(moving picture experts group 7) descriptions of the MPEG-4 contents, and generating an XML (extensible markup language) based textual format file including the MPEG-7 descriptions;
an extensible description/binary converter for receiving the XML based textual format file including the MPEG-7 descriptions generated by the extensible description generator, and generating them as a binary file; and
an XML based contents storage unit for storing the XML based textual format file generated by the extensible description generator and the binary file generated by the extensible description/binary converter.

2. The device of claim 1, further comprising:
an MPEG-4 contents storage unit for storing the object-based MPEG-4 contents; and
an MPEG-7 description generator for generating MPEG-7 descriptions of the MPEG-4 contents stored in the MPEG-4 contents storage unit.

3. The device of claim 1, wherein the XML based contents storage unit stores either of the textual format or the binary file generated on the XML basis, and storage information of the MPEG-4 contents storage unit of the MPEG-4 contents related to the corresponding XML based file.

4. An object-based MPEG-4(moving picture experts group 4) contents editing and authoring method comprising:
receiving one of a textual file and an internal data structure of object-based MPEG-4 contents stored in a contents database;
receiving MPEG-7(moving picture experts group 7) descriptions of the object-based MPEG-4 contents; and
combining either of the textual file or the internal data structure of the object-based MPEG-4 contents with the MPEG-7 descriptions, generating them into an XML (extensible markup language) based textual format file, and storing the XML based textual format file.

5. The method of claim 4, further comprising converting the XML based textual format file into a binary file, and storing the binary file.

6. An object-based MPEG-4(moving picture experts group 4) contents editing/authoring and retrieving device comprising:
a contents editor/author for receiving either of an MPEG-4 textual format or internal data structure information of object-based MPEG-4 contents, and MPEG-7 (moving picture experts group 7) descriptions of the MPEG-4 contents, combining them, editing or authoring them as an XML (extensible markup language) based textual format file or a binary file, and storing it;
a contents storage unit for extracting MPEG-7 description information of the XML based textual format file edited, authored, and stored by the contents editor/author, and storing the MPEG-7 description information for a retrieval process; and
a retrieval browser/reproducer for providing a user interface for retrieving MPEG-7 description information stored in the contents retriever, and reproducing the retrieved contents.

7. The device of claim 6, wherein the contents editor/author comprises:
an extensible description generator for receiving either of an MPEG-4 textual format or internal data structure information of object-based MPEG-4 contents, and MPEG-7 descriptions of the MPEG-4 contents, and generating an XML based textual format file including the MPEG-7 descriptions;
an extensible description/binary converter for receiving the XML based textual format file including the MPEG-7 descriptions generated by the extensible description generator, and generating them as a binary file; and
an XML based contents storage unit for storing the XML based textual format file generated by the extensible description generator and the binary file generated by the extensible description/binary converter.

8. The device of claim 6, wherein the contents retriever comprises:
a file parsing module for receiving the XML based textual format file or the binary file produced using the MPEG descriptions, and extracting MPEG-7 descriptions included in the corresponding file;
an MPEG-7 description storage unit for generating the MPEG-7 description information extracted from the file parsing module into a database, and storing the information; and
a retrieval module for retrieving the MPEG-7 description information stored in the MPEG-7 description storage unit according to a request by a user, and outputting corresponding results.

9. The device of claim 6, wherein the retrieval browser/reproducer comprises:
a retrieval browser for receiving a retrieval request from a user, commanding the contents retriever to perform retrieval, receiving retrieval results, and outputting them to the user; and
a reproducer for reproducing the contents retrieved through the retrieval browser.

10. An object-based MPEG-4(moving picture experts group 4) contents retrieving method comprising:
(a) receiving a user's request for contents retrieval through a retrieval browser, and retrieving MPEG-7 (moving picture experts group 7) description information stored in an MPEG-7 description storage unit at a retrieval module;
(b) receiving retrieval results from the retrieval browser, and displaying the retrieval results;
(c) allowing the user to select desired contents from among the displayed results; and
(d) loading the contents selected from the retrieval browser from a storage unit, and driving a reproducer to reproduce the loaded data.

11. The method of claim 10, wherein (a) further comprises:
allowing the user to input a keyword through the retrieval browser and request retrieval;
retrieving an MPEG-7 description information storage unit at the retrieval module by using the keyword; and
generating retrieval results into a list, and transmitting the list to the retrieval browser.

12. The method of claim 10, wherein (d) comprises analyzing original contents storage information stored in the MPEG-7 description storage unit, and loading the original contents storage information.
